(19) United States
(12) Patent Application Publication
(10) Pub. No.: US 2013/0327694 A1
(43) Pub. Date: Dec. 12, 2013

(54) Digester gas mixer for liquid waste treatment

(71) Applicants: Kristinn G. Drewry, Bellevue, WA (US); Richard J. Koopmans, Oroville, WA (US); William A. Arnold, Akron, OH (US)

(72) Inventors: Kristinn G. Drewry, Bellevue, WA (US); Richard J. Koopmans, Oroville, WA (US); William A. Arnold, Akron, OH (US)

(21) Appl. No.: 13/947,994

(22) Filed: Jul. 22, 2013

Related U.S. Application Data
(63) Continuation-in-part of application No. 12/462,990, filed on Aug. 12, 2009, now abandoned.
Application No. 12/462,990 is a continuation-in-part of application No. 13/830,455, filed on Mar. 14, 2013.
(60) Provisional application No. 61/741,313, filed on Jul. 16, 2012.

(51) Int. Cl. C02F 11/04

(52) U.S. Cl. CPC C02F 11/04
USPC 210/150

(57) ABSTRACT

A mixer for anaerobic decomposition of sludge in a digester, captures and compresses biogas emitted by the decomposing sludge. The compressed biogas proceeds through supply lines to gas accumulating apparatus mounted in the lower portion of the digester, close to or on the digester floor. Biogas accumulates in the gas accumulating apparatus to emerge as large mixing bubbles from 6 inches to 10 feet in diameter along their largest dimension. The mixing bubbles are large enough to generate a strong mixing current in the sludge that moves sludge as the bubbles rise to the surface. The mixing current mixes the sludge containing dissolved and suspended pollutants to promote the conversion of the pollutants by microorganisms contained in the sludge.

### CROSS REFERENCE TO RELATED APPLICATION

This application is a continuation-in-part of and claims priority to U.S. patent application Ser. No. 12/462,990 for DIGESTER GAS MIXER FOR WASTE LIQUID TREATMENT, filed Aug. 12, 2009.

This application is also a continuation-in-part of and claims priority to U.S. patent application Ser. No. 13/830,455 for MIXING BUBBLE GENERATOR AND INSTALLATION CONFIGURATION, filed Mar. 14, 2013, which claims benefit of U.S. provisional patent application No. 61/741,313, filed Jul. 16, 2012.

### BACKGROUND OF THE INVENTION

1. Field of the Invention

This invention relates to mixers for mixing liquids by the injection of gas to form large mixing bubbles. More specifically, this invention relates to utilizing biogas for such mixers employed in the anaerobic decomposition of waste liquids.

2. Description of the Related Art

Water is frequently used to transport unwanted materials—waste—to a facility where the waste is removed or neutralized in the water. For example, water carries most sewage and industrial waste, such as chemicals, in the form of wastewater to a treatment facility where the water is treated and then returned to the environment for future use. Wastewater treatment is a subset of waste liquid treatment generally, in which liquid with dissolved and suspended toxins, high solids and high biological oxygen demand is decomposed to yield more environmentally friendly material.

Such liquid waste treatment processes involve sequential separation of waste components from the liquid waste. Of central concern in the treatment of liquid waste is the removal of solid components of the waste liquid. Solid waste components in liquid waste may be categorized as settleable solids, suspended solids, and dissolved solids. Referring to FIG. 1, depicted is a diagram illustrating a typical liquid waste treatment process. Raw waste 102, comprising water with both organic and inorganic waste is submitted to pretreatment 104, in which gross untreatable solids 106 such as rock, grit and plastic, are separated from the stream of waste. The resulting pre-treated liquid waste 108, comprised of water with fine settleable solids, suspended solids and dissolved solids is placed in a settling tank or primary clarifier 110, in which settleable solids in the waste are allowed to settle out. The settleable solids 112 that have settled to the bottom of primary clarifier are then transported to a digester 114.

With the removal of settleable solids 112 from primary clarifier 110, the supernatant fluid 122, comprised of water with suspended and dissolved solids, is transported to a secondary treatment facility 124, which typically includes an aerobic—with oxygen—portion in which bacterial and other microorganisms are provided dissolved oxygen to promote their consumption of the carbonaceous and nutrient materials, and an anoxic—oxygen from a nitrate/nitrite source—portion in which the bacteria and other microorganisms use the oxygen in the nitrate/nitrite for their metabolic functions. The biological processing of the waste liquid in the secondary treatment facility 124 results in a liquid 126 consisting principally of microbes as settleable biological material and water substantially depleted of biologically active organic pollutants.

After biological remediation in secondary treatment facility 124, liquid 126 is transported to secondary clarifier 128, in which the settleable semi-solid biological material is allowed to settle out, resulting in biological sludge 130 which is transported to digester 114. The supernatant fluid 132 is transported from tank 128 as effluent in which a substantial portion of inorganic and organic pollutants have been removed by the foregoing described treatment process.

The present invention is directed toward digesters, such as digester 114 depicted in FIG. 1. In such digesters, sludge (comprised of settleable materials, obtained both before 112 and after 130 secondary treatment 124) is allowed to settle further, resulting in supernatant liquid 116 which is typically transported back through the liquid waste treatment process for further purification as described above. The remaining semi-solid sludge is further allowed to digest anaerobically in digester 114 in the absence of oxygen. In the digestion of sludge, organic compounds in the sludge are decomposed by fermentation activities of anaerobic microbes, to form biogas 120, consisting principally of methane (CH₄) and carbon dioxide (CO₂). These anaerobic microbes are principally mesophilic, metabolizing organic compounds optimally at temperatures in the range of about 95 to 105 degrees Fahrenheit. Accordingly, it is common practice to maintain decomposing sludge in this temperature range by circulating digester contents through heat exchangers.

The anaerobic decomposition of sludge reduces its potential toxicity to the environment, as measured by biological oxygen demand. When anaerobic decomposition has progressed sufficiently that the biological oxygen demand of the sludge has been reduced to an acceptable level, digested sludge 118 is removed from digester 114 and disposed of in the environment by various methods well known to those of skill in the liquid waste processing art.

It is important that the semi-solid sludge in the digester be mixed regularly to assure efficiency of the digestive process. While many waste treatment facilities simply rely on the circulation of sludge provided by heat exchange, as discussed above, various additional methods of mixing sludge in digesters have been employed in the prior art, each with various shortcomings. The present invention is directed to address such shortcomings.

Mechanical mixers, typically employing a screw or a blade, have been used to mix the sludge contents of digesters. While mechanical mixers are very common, they all require fairly large amounts of energy, typically in the form of electricity supplied to electric motors to drive the mixers. Further, such mixers are prone to mechanical failure. Yet further, many mechanical mixers are not thoroughly effective, failing to supply adequate mixing to all regions of the sludge in the digester, resulting in uneven biological decomposition of the sludge over time.

For secondary treatment of liquid waste, effective mixers, such as described in U.S. Pat. Nos. 7,524,419, 7,374,675 and 7,282,141 (all to the inventors of the present invention), have been developed that employ compressed gas, such as air, to form large mixing bubbles that generate currents that mix the waste liquid. Such mixers are much more efficient and trouble-free than mechanical mixers. However, bubble mixers using compressed gas containing oxygen, such as air, are not useable in digesters, because digesters rely for operation in large part on the activity of strictly anaerobic microbes, organisms which cannot function effectively in the presence of even relatively small amounts of oxygen. To provide the benefit of bubble mixing to digesters, what is needed is a bubble mixer employing gas that is essentially free of oxygen. By utilizing the gases emitted in anaerobic digestion of sludge, such a mixer can further realize significant economic efficiencies of operation.

In the Perth™ Digester Gas Mixer supplied by Siemens Water Technologies of Waukesha, Wis., biogas emitted in anaerobic sludge decomposition is collected and compressed to flow through large bore straight vertical pipes (called “lances”) depending into the sludge to various depths. The biogas is emitted from the lances in the form of bubbles of relatively moderate size, typically less than one inch in diameter. The moderate turbulence in the digester caused by the emission of these moderately sized bubbles of biogas from the bottom openings of the lances is claimed to provide mixing of materials in the digester to facilitate decomposition.

The Perth and similar mixers, however, are subject to several limitations. First, in a typical installation, the Perth lances do not extend to the very bottom of the digester. Accordingly, whatever turbulence is caused by the bubbles emitted from the lances has little effect upon materials settled to the bottom of the digester. These materials remain essentially undisturbed, with no improvement in their decomposition brought about by use of the Perth technology. Second, and significantly as concerns the present invention, while the bubbles emitted from the bottom opening of a Perth lance may create some turbulence as they rise through the upper portion of the digester, the amount of turbulence caused by these moderately sized bubbles is not sufficient to mix the entire contents of the tank adequately.

In U.S. Pat. No. 4,824,571, inventors Ducellier et al. note the fact that general bubbles of the biogas emitted in anaerobic sludge decomposition in a tank produce insufficient turbulence to mix the entire contents of the tank adequately. Ducellier et al. address this problem by subdividing the tank into a plurality of sectors and then directing all the biogas produced by the tank successively into each sector. While the biogas from the tank emitted in moderately sized bubbles is insufficient to mix the entire contents of the tank in one session, it is sufficient to mix the entire contents of the portion of the tank contained in one sector. By mixing each sector in succession, Ducellier et al. are able to use moderately sized bubbles to mix the tank's contents.

What is needed is an improved apparatus for mixing the contents of anaerobic liquid waste treatment tanks, employing bubble mixing technology in an effective manner to mix the entire contents of a tank without requiring the complexity of successively mixing each of a plurality of sectors in the tank. Such an improved apparatus uses solely the biogas generated by the tank to provide bubbles with sufficient turbulence to mix the entire contents of a tank comprised of a single, undivided sector.

### BRIEF SUMMARY OF THE INVENTION

Embodiments of the present invention comprise a mixer for anaerobic decomposition of sludge in a digester employed in waste liquid treatment, in which biogas emitted by the decomposing sludge is captured and compressed. The compressed biogas proceeds through supply lines to apparatus for accumulating gas for the formation of large mixing bubbles, the apparatus mounted in the lower portion of the digester, close to or on the digester floor. Gas accumulating apparatus may be bubble-forming plates or pivoting bucket assemblies. Biogas accumulates in the gas accumulating apparatus, periodically to be emitted by the apparatus into the tank as large mixing bubbles from 6 inches to 10 feet in diameter along their largest dimension. The mixing bubbles are large enough to generate a substantial mixing current in the sludge, moving sludge as the bubbles rise to the surface. The mixing current mixes the sludge throughout the tank, slurrying bacteria and other microorganisms within the sludge to promote the biological conversion of the pollutants contained in the sludge.

### BRIEF DESCRIPTION OF THE DRAWINGS

The foregoing objects, as well as further objects, advantages, features and characteristics of the present invention, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 depicts prior art liquid waste treatment, described above in reference to the background of the invention;

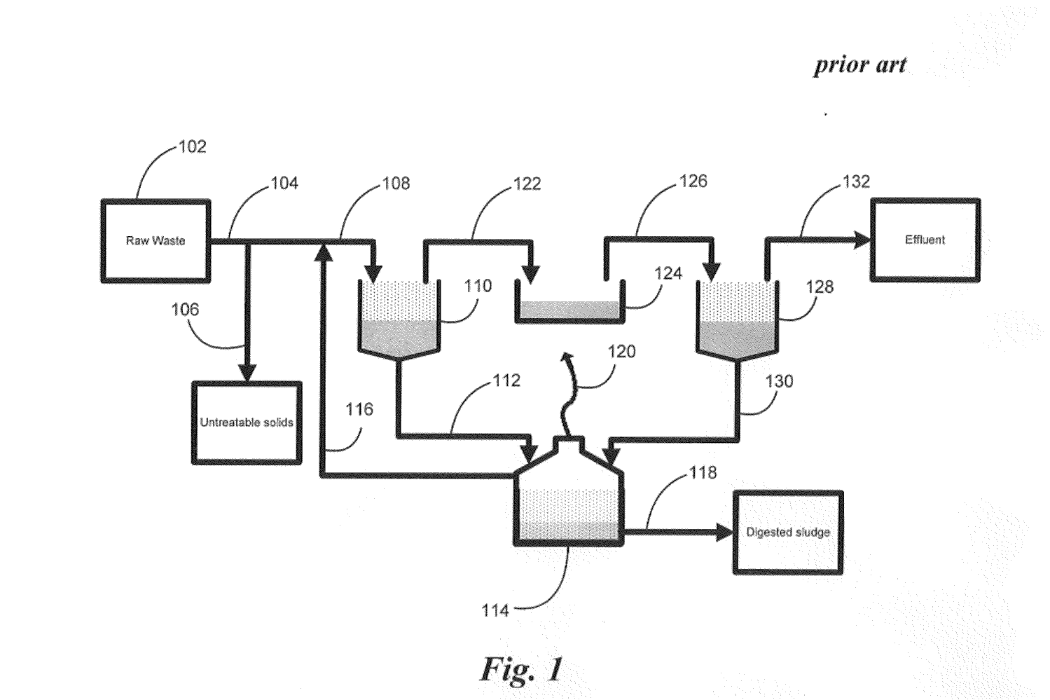

FIG. 2a is a perspective view of a bubble forming plate, according to an embodiment of the invention;

FIG. 2b is a perspective view of a bubble forming plate, according to another embodiment of the invention;

FIG. 2c is an elevation view of a pivoting gas-receiving bucket in an embodiment of the invention;

FIG. 2d is an overhead view of a pivoting gas-receiving bucket in an embodiment of the invention;

FIG. 2e is a diagram of the action of a gas-receiving bucket on obtaining sufficient gas to cause buoyancy leading to discharge of a large mixing bubble;

FIGS. 2f-i are diagrams of the operation of an alternative embodiment of a pivoting gas-receiving bucket;

FIG. 3 is a diagrammatic layout of distribution lines and forming plates located and arranged in a digester, according to an embodiment of the invention;

FIG. 4 is a view of a digester containing a mixer according to the present invention, illustrating the mixing currents generated by large mixing bubbles; and

FIG. 5 depicts a closed digester in which biogas from the anaerobic decomposition of sludge is used to generate the large mixing bubbles according to an embodiment of the invention.

### DETAILED DESCRIPTION OF THE INVENTION

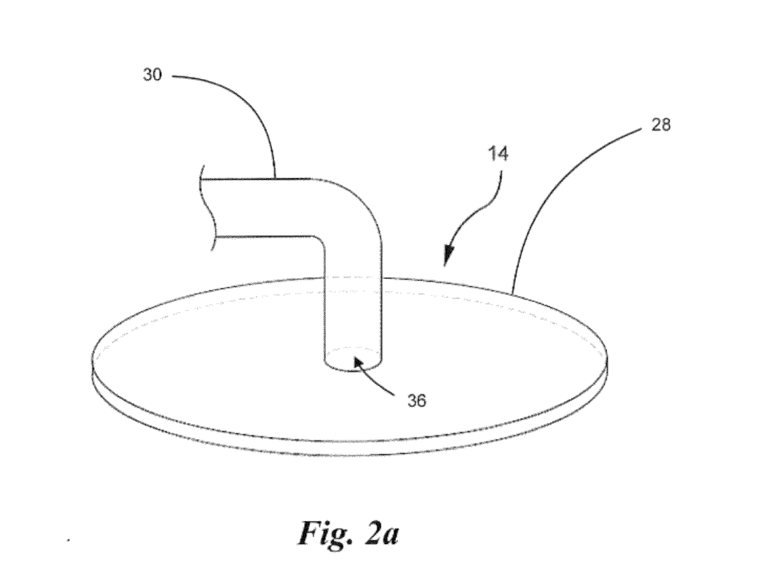

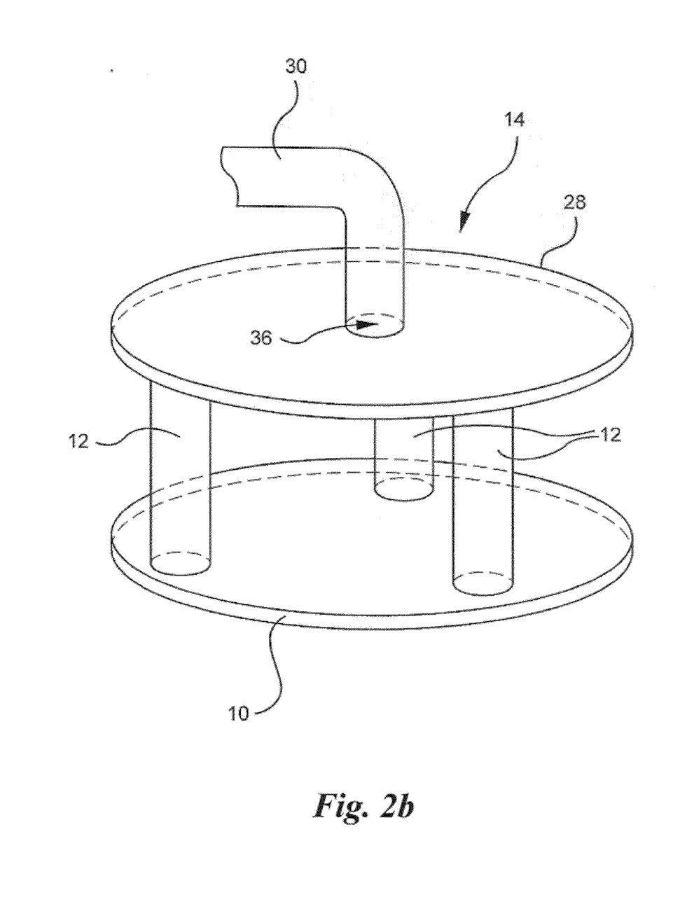

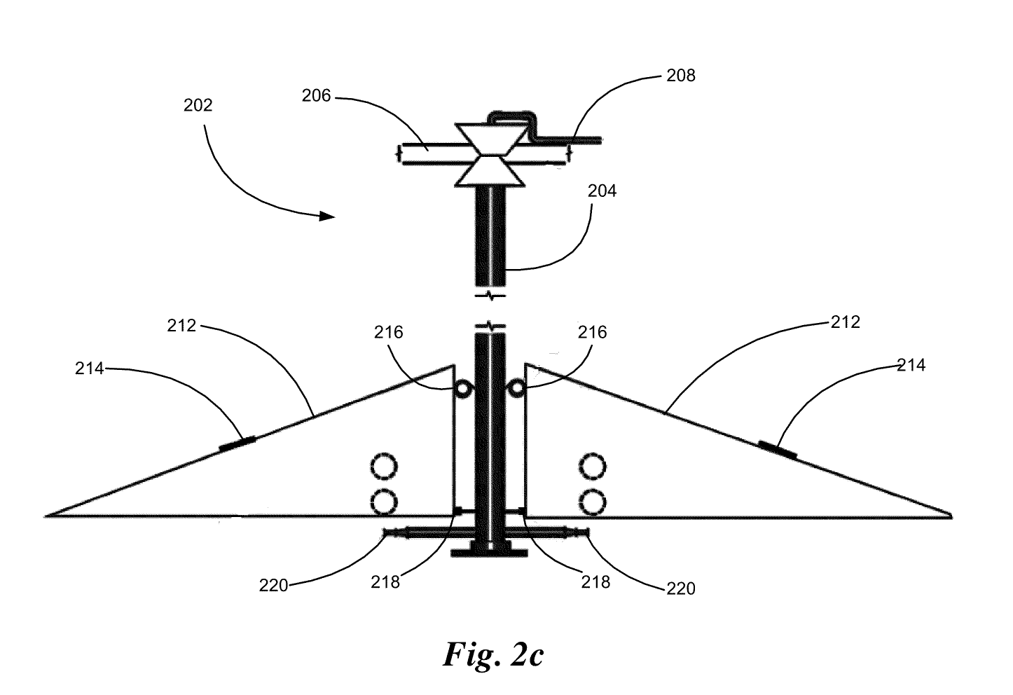

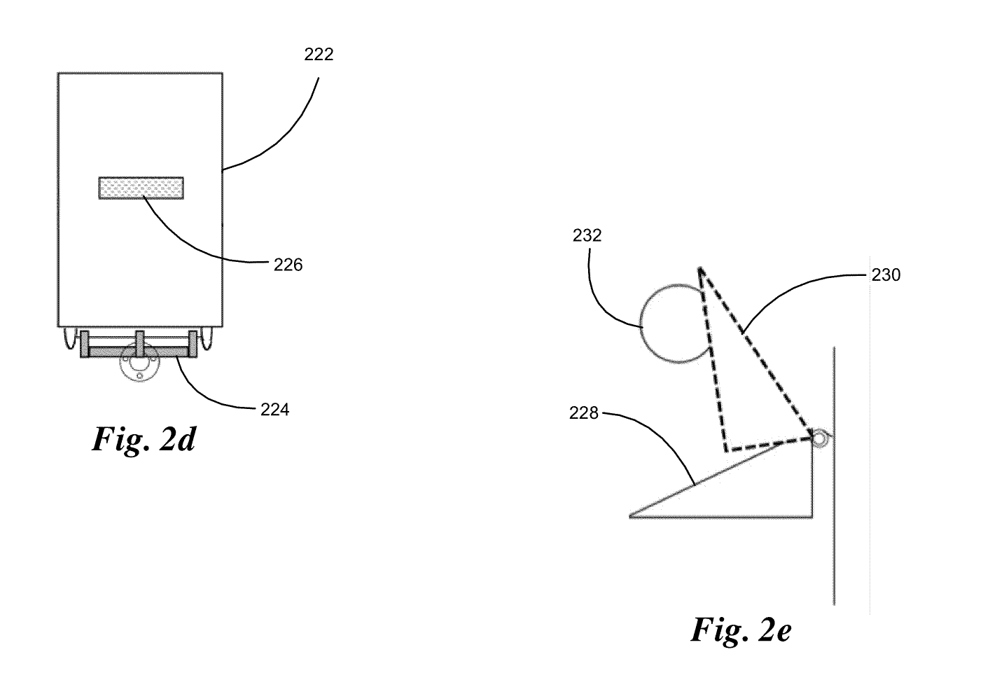

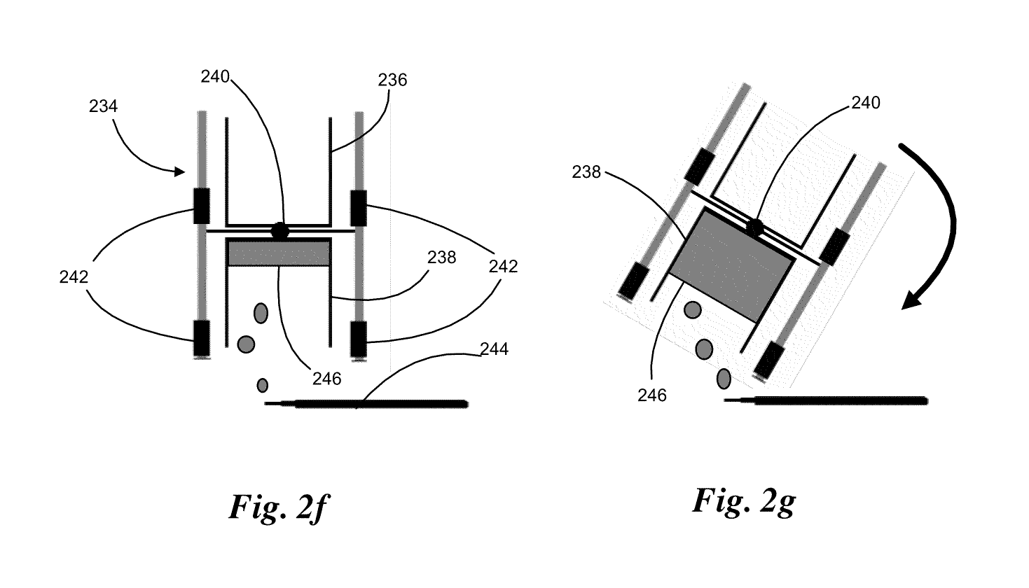

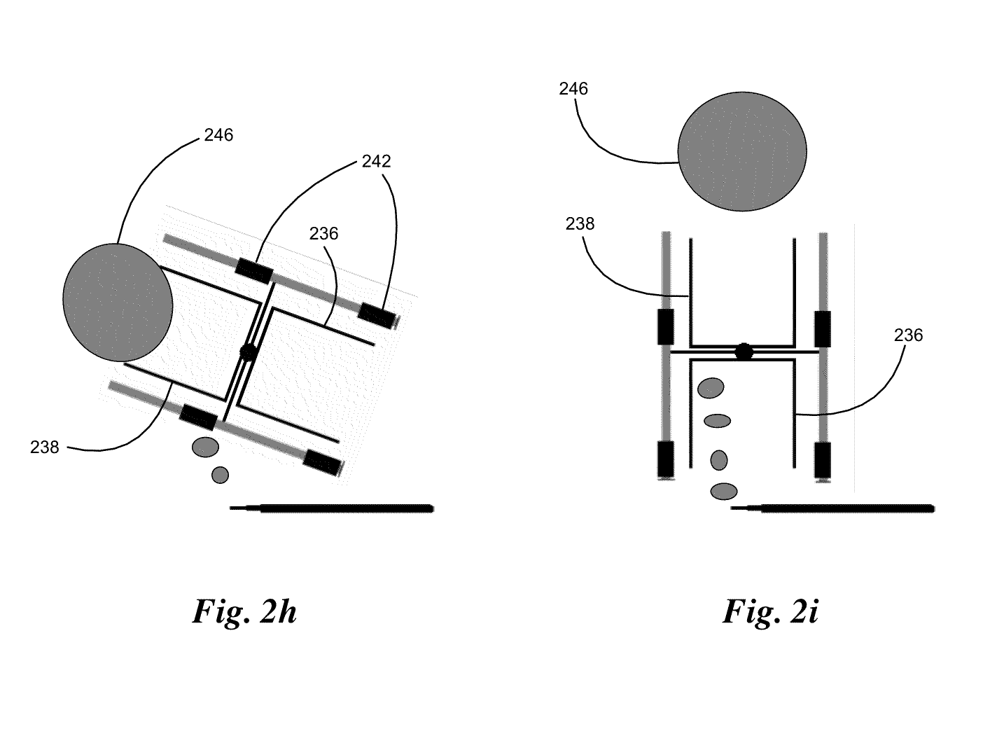

The present invention forms large mixing bubbles from biogas produced in a digester by use of gas accumulating apparatus. In some embodiments, such gas accumulating apparatus comprise bubble-forming plate assemblies that are placed in the digester in which mixing is desired. Turning to the assembly of such plates, FIG. 2a illustrates an embodiment of a bubble forming plate assembly 14 according to an embodiment of the present invention. Plate assembly 14 is immersed in sludge to be mixed. A gas distribution line 30 provides compressed gas through orifice 36 to the underside of plate 28. Plate 28 is typically made of corrosion resistant metal, or metal that has been treated for corrosion resistance, and in embodiments is on the order of eight inches in diameter. In any case, the gas, being lighter than the sludge, accumulates on the underside of plate 28 until such a large quantity has accumulated that it escapes around the edges of plate 28 to form a large bubble.

For effective mixing, plates are placed on or near the floor of the digester. An alternative embodiment of the bubble forming plate assembly 14 is illustrated in FIG. 2b, in which forming plate 28 sits upon a plurality of legs 12 which in turn are appended to a mounting plate 10. In this embodiment, mounting plate 10 rests on the bottom of the digester, in some embodiments held in place simply by the weight of plate assembly 14. In other embodiments, mounting plate 10 is affixed to the bottom of the digester by bolting, welding or other means of affixing well known to those in the art. In other embodiments, as described in U.S. patent application Ser. No. 12/290,661 by the inventors of the present invention, incorporated herein in its entirety by reference, mounting plate 10 is a strong permanent magnet which adheres to the bottom of any tank of ferromagnetic material.

In other embodiments, gas accumulating apparatus comprise pivoting bucket assemblies. FIG. 2c depicts an embodiment of the pivoting bucket 202, wherein a vertical tubular piece 204 depends from a horizontal bridge piece 206. The horizontal bridge piece 206 may be any rigid bar, such as a metal I-beam, spanning across the top of the tank. In the depicted embodiment, the tubular vertical piece 204 receives a supply line 208 with biogas in at its top. The supply line 208 runs through the tubular vertical piece 204 down to gas injectors 220 extending from the vertical piece 204 from its bottom. Gas bucket accumulators 212 with counterweights 214 are pivotally attached to the vertical piece 204 with pivoting connectors 216 and are normally retained against the vertical piece 204 by stops 218. Biogas enters the gas buckets 212 from the gas injectors 220.

FIG. 2d is an overhead schematic view of the gas bucket or accumulator 222 in an embodiment of the gas accumulating apparatus, showing the pivot hinge 224 and counterweight 226.

FIG. 2e shows the action of the gas accumulating apparatus depicted in FIGS. 2c and 2d, with the normal, gas-receiving position of the bucket accumulator 228 shown in solid line and the buoyed, gas-releasing position of the bucket accumulator 230 in dotted line, a large mixing bubble 232 released to mix the tank.

FIGS. 2f-2i depict an alternative embodiment of pivoting bucket assemblies employed in embodiments of the invention. These figures depict the gas accumulating apparatus 234 as two buckets, 236, 238 joined bottom to bottom to form a roughly cylindrical object with openings at the top and at the bottom and a solid divider in the middle. The assembly further comprises a pivot 240 connected to the buckets at the point of their junction, enabling the conjoined buckets to rotate about the pivot point. Yet further, sliding weights 242 are connected to the apparatus to provide additional torque to the pivoting buckets at certain points in rotation of the buckets around the pivot point. In operation, the apparatus is positioned over a source of gas 244 and the rotational position of the buckets is such that the lower bucket is inverted, receiving gas, while the upper bucket is upright and filled with the surrounding liquid. In FIG. 2f, the lower bucket is 238 and already partially full of gas 246. Sliding counterweights 242 are positioned toward bucket 238 and away from bucket 236.

In FIG. 2g, lower bucket 238 now contains more gas 246 from source 244, creating sufficient buoyancy in bucket 238 to initiate rotation of the apparatus 234 about pivot 240 in the direction indicated by the heavy curved arrow.

In FIG. 2h, apparatus 234 has further rotated about the pivot in the direction of the heavy curved arrow, with the effect that sliding counterweights 242 have slid away from bucket 238 toward bucket 236. At this point, with bucket 238 trending toward an upright position, gas 246 contained in bucket 238 is released from bucket 238.

In FIG. 2i, gas 246 has been released from bucket 238 as a large bubble. Sliding counterweights 242 are positioned toward bucket 236, which is now in the lower position to receive gas from source 244, repeating the cycle.

Just as with embodiments employing bubble forming plate assemblies, in embodiments employing pivoting bucket assemblies as the gas accumulating apparatus, effective mixing of tank contents calls for placing the gas accumulating apparatus on or near the floor of the digester.

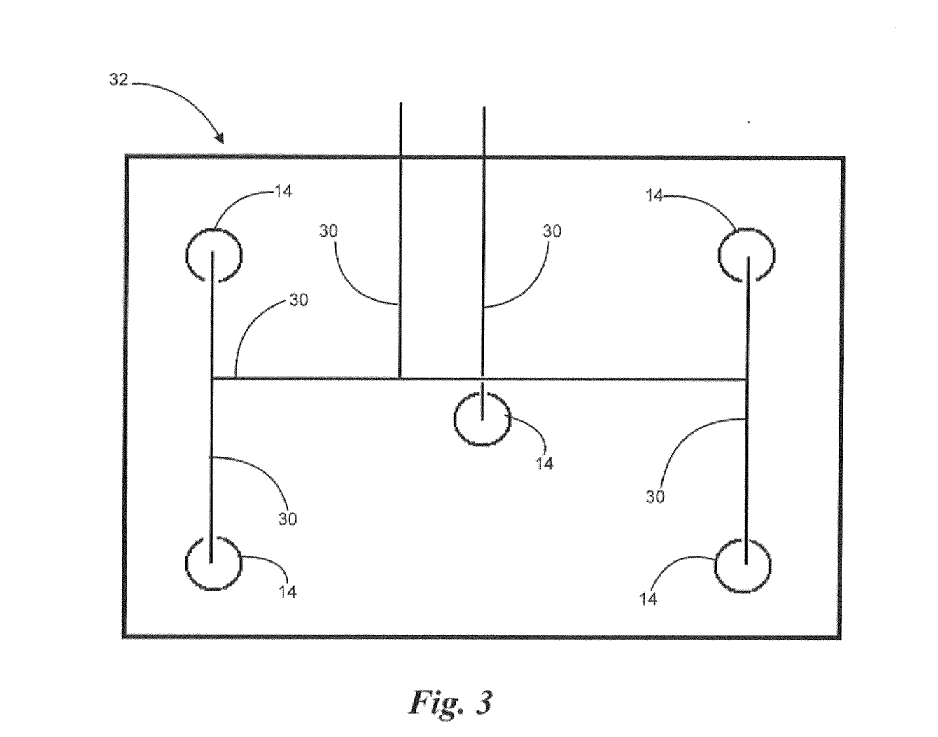

In any case, in typical installations of the present invention, a plurality of gas accumulating apparatus for the production of large mixing bubbles are distributed throughout the lower portion of the digester. Turning to FIG. 3, illustrated is a diagrammatic layout of an embodiment employing bubble forming plate assemblies for the gas accumulating apparatus in a digester 32. In the depicted embodiment, five bubble plate forming assemblies 14 are spaced throughout the bottom of digester 32, the assemblies 14 supplied by gas supply lines 30. As will be appreciated, the exact number and placement of gas accumulating apparatus such as plate assemblies 14 for any particular digester will be determined by the configuration of the digester 32 and the mixing requirements for treatment of the sludge.

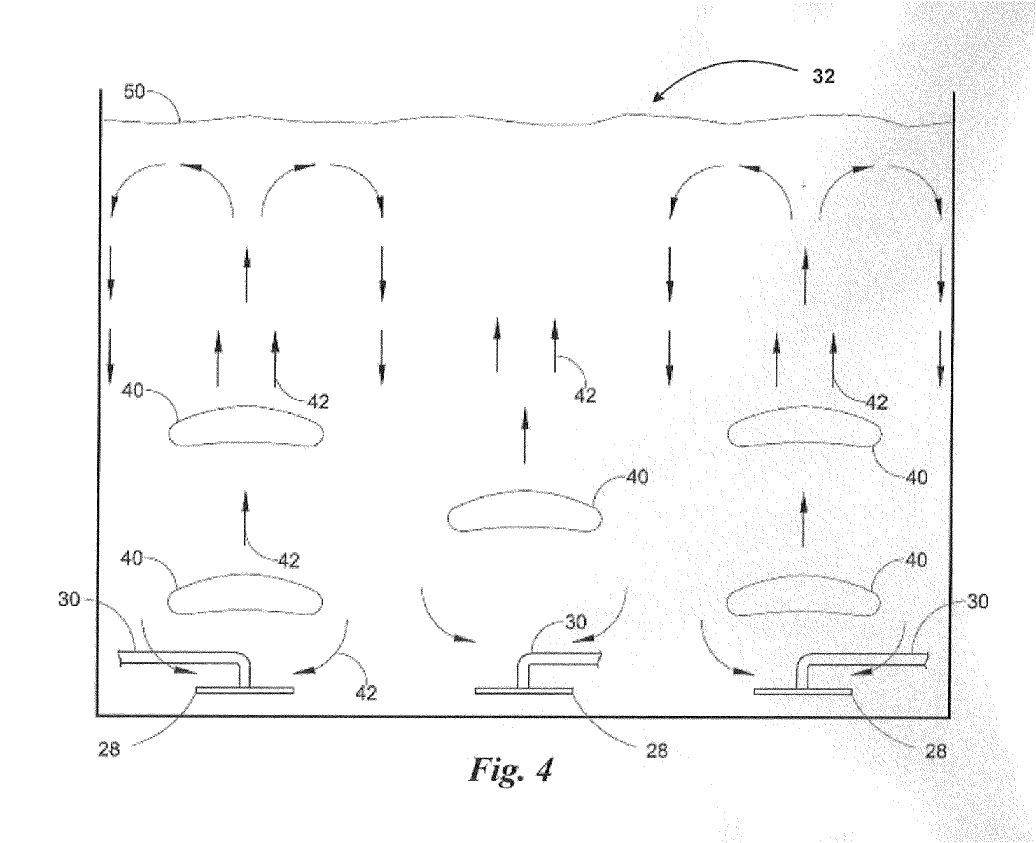

FIG. 4 depicts the mixing functionality provided by the present invention. Bubble forming plates are illustrated, but persons of skill in the art will appreciate that pivoting bucket assemblies may be used as the gas accumulating apparatus in alternative embodiments and that the general discussion of mixing by large bubbles applies equally to large bubbles produced by either gas accumulating apparatus.

Disposed in digester 32 are a plurality of bubble forming plates 28 (three depicted here). As described in reference to FIGS. 2a and 2b above, compressed gas is supplied by supply lines 30 to accumulate on the underside of a plate 28 until such a large quantity has accumulated that it escapes around the edges of plate 28 to form a large bubble 40. The mixing bubbles 40 generate the mixing currents indicated by the arrows 42 (28 arrows shown but only 5 labeled with the reference number 42 for clarity) that mix the sludge 50, bacteria (omitted for clarity) and other microorganisms (also omitted for clarity). The strength of the mixing currents depends on the speed at which each mixing bubble 40 travels through the sludge and the size of each bubble 40.

The speed of the mixing bubble 40 depends on the density of the compressed gas relative to the density of the sludge 50, and the bubble's shape. The greater the difference between the densities of the sludge 50 and the compressed gas, the faster the mixing bubbles 40 rise through the sludge 50. The more aerodynamic the shape of the bubble 40 becomes the faster the bubble 40 rises through the sludge 50. For example, in one embodiment, the bubble 40 forms a squished sphere—a sphere whose dimension in the vertical direction is less than the dimension in the horizontal direction. In other embodiments, the bubble 40 forms a squished sphere having the trailing surface—the surface of the bubble 40 that is the rear of the bubble 40 relative to the direction in which the bubble 40 moves—that is convex when viewed from the direction that the bubble 40 moves.

The size of the mixing bubble 40 depends on the flow rate of the compressed gas into the sludge 50. The flow rate depends on the size of the orifice 36 (FIG. 2a) and the gas injection pressure. As one increases the compressed gas injection pressure, one increases the amount of gas injected into the sludge 50 over a specific period of time that the valve 29 is open. And, as one increases the area of the orifice 36, one increases the amount of compressed gas injected into the sludge 50 over a specific period of time that the valve 29 is open. As one increases the diameter of the forming plate 28 one increases the amount of gas the forming plate 28 can hold before the gas escapes it. For example, in one embodiment the size of the bubble 40 is approximately 6 inches across its largest dimension. In other embodiments, the bubble 40 is approximately 10 feet across in largest dimension.

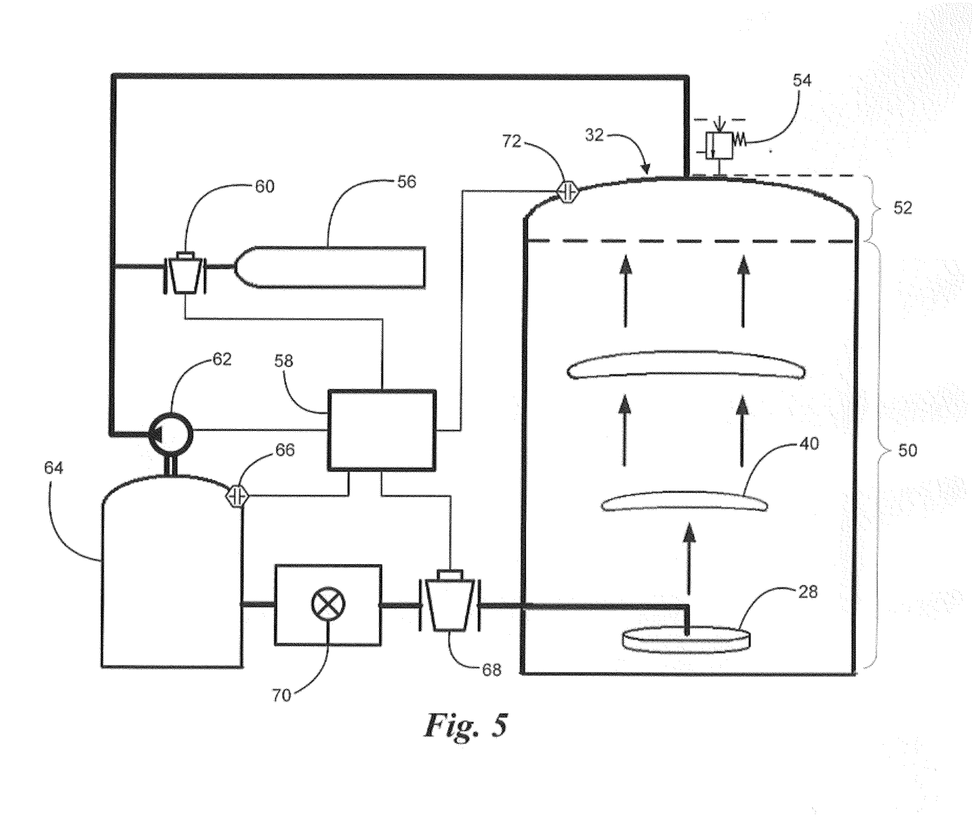

Turning now to FIG. 5, depicted is the use of the present invention to mix sludge in waste liquid treatment. Sealed digester 32 has been partially filled with sludge 50. It will be noted that digester 32 is not divided into sectors, nor is such a division needed in the present invention; rather, digester 32 contains a single sludge treatment zone for sludge 50. Above the surface of sludge 50 is headspace 52 in which gas can accumulate. Digester 32 is fitted with pressure relief valve 54 to regulate the pressure of accumulated gas in headspace 52 to the range of gas pressure consistent with optimal growth of the digester anaerobic microbes. In some embodiments, pressure in headspace 52 is limited to 20 pounds per square inch or less of gas. Further, because of environmental concerns, if relief valve 54 vents significant quantities of biogas, provisions must be made for environmental remediation of such emissions (not depicted), by methods well known to those of skill in the art.

In the depicted embodiment, digester 32 is further outfitted with bubble forming plates 28 as gas accumulating apparatus (only one plate 28 illustrated here for the purpose of clarity). As will be appreciated by those in the art, the present invention may alternatively employ pivoting bucket assemblies (not depicted) as gas accumulating apparatus.

When sludge 50 is first placed in digester 32, the population and activity of anaerobic microorganisms in sludge 50 generates little biogas. While not required for operation in all embodiments of the present invention, to provide accelerated mixing of sludge 50 in its early stages of anaerobic decomposition, the depicted embodiment of the invention employs an initial supply of anaerobic gas, such as carbon dioxide, in auxiliary gas pressure tank 56. During the early stages of anaerobic decomposition of sludge 50, a controller 58 opens a valve 60, providing gas from auxiliary gas pressure tank 56 to compressor 62. As anaerobic decomposition of sludge 50 in digester 32 progresses, anaerobic organisms in sludge 50 flourish and multiply, producing increasing amounts of biogas, which accumulates in headspace 52. When digester sensor 72 indicates that sufficient biogas has accumulated in headspace 52, biogas instead of gas from auxiliary gas pressure tank 56 is supplied to compressor 62 and controller 58 closes valve 60, ceasing use of any gas other than biogas for mixing.

Compressor 62, under control of controller 58, is activated to supply pressurized gas to pressurized gas storage tank 64 when tank pressure sensor 66 indicates that the pressure of gas in pressurized gas storage tank 64 is below a predetermined lower bound. Compressor 62 continues to compress gas into pressurized gas storage tank 64 until tank pressure sensor 66 indicates the pressure of gas in pressurized gas storage tank 64 has reached a predetermined upper bound. As will be appreciated by those in the art, the predetermined values of tank pressure lower and upper bounds can vary widely depending upon the particulars of the embodiment, including the capacity of pressurized gas storage tank 60, efficient optimization of the duty cycle of compressor 62 and the volume of gas required over time by the particular implementation of the mixer of the present invention. Embodiments may utilize a lower bound of roughly 100 pounds of pressurized gas per square inch, while the upper bound may be determined by the operational limits of tank 64 and regulator 70 (discussed below).

To mix the contents 50 of digester 32, controller 58 periodically directs pulse valve 68 to open, whereby pressurized gas from pressurized gas storage tank 60, pressure regulated through regulator 70, flows through supply line 30 to accumulate under plate 28 to form large mixing bubbles 40, mixing the contents 50 of digester 32 by convection currents as described above in reference to FIG. 4. In some embodiments, regulator 70 controls the pressure of gas flowing through valve 68 to 40 to 60 pounds per square inch. For regulator 70, such embodiments may utilize the B20 and B21 QIX filter/regulators supplied by Parker-Hannifin Corp., Pneumatic Division of Richland, Mich. For pulse valve 68, embodiments utilize Type 2000 threaded port valve from Christian Bürkert GmbH & Co. KG of Ingelfingen, Germany.

Advantageously, because of the mixing efficiency of its large bubbles, the present invention provides mixing of all of the contents of digester 32 with the biogas produced by sludge 50 in digester 32 without needing to resort to sequential mixing of sectors within the digester.

As will be appreciated by those in the art, considerable variation and refinement of the embodiment described in the foregoing is possible while still keeping with the spirit of the present invention. For example, instead of employing the bubble mixer to mix sludge 50 in the early stages of anaerobic decomposition, a mechanical mixer may be used to mix sludge 50 until such time as sufficient biogas is produced by sludge 50 to operate the bubble mixer, thereby obviating the need for auxiliary gas pressure tank 56 and associated valve 60 altogether. Additionally, embodiments may be constructed wherein, when anaerobic decomposition of sludge 50 has progressed sufficiently that a quantity of biogas is produced, a portion of the biogas may be treated and used as fuel to power compressor 62 in a manner well known to those in the alternative energy arts.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. A system for mixing sludge from waste liquid treatment, the system comprising:
a digester containing a single sludge treatment zone, the zone having an upper portion and a lower portion, and
a mixer for generating large mixing bubbles within the lower portion of the sludge treatment zone, the mixer comprising:
a source supplying anaerobic gas, the source comprising stored biogas generated by sludge within the digester;
at least one gas accumulating apparatus disposed in the lower portion of the digester;
at least one supply line for transporting anaerobic gas from the source of anaerobic gas to the gas accumulating apparatus; and
a valve within the supply line, the valve controllably supplying pulses of the anaerobic gas from the supply line to the gas accumulating apparatus.

2. A system according to claim 1, wherein the at least one gas accumulating apparatus comprises a bubble forming plate.

3. A system according to claim 1, wherein the at least one gas accumulating apparatus comprises a pivoting bucket assembly.

4. A system according to claim 1, further comprising:
a means for detecting the quantity of stored biogas available for mixing the sludge;
an auxiliary tank of compressed anaerobic gas connected by a normally closed valve to the supply line,
wherein, when insufficient stored biogas is detected for mixing the sludge, the normally closed valve is opened, the source supplying anaerobic gas further comprising the compressed anaerobic gas in the auxiliary tank.

5. A mixer for mixing sludge in a waste liquid treatment system digester, the digester having an upper portion and a lower portion, the mixer comprising:
at least one gas accumulating apparatus disposed in the lower portion of the digester;
a means for capturing and storing biogas produced by decomposing sludge in the digester, such means connected to provide stored biogas to at least one supply line, the supply line transporting gas to the gas accumulating apparatus; and
a valve within the supply line, the valve supplying pulses of stored biogas from the supply line to the gas accumulating apparatus.

6. A system according to claim 5, wherein the at least one gas accumulating apparatus comprises a bubble forming plate.

7. A system according to claim 5, wherein the at least one gas accumulating apparatus comprises a pivoting bucket assembly.
